(19) United States
(12) Patent Application Publication
(10) Pub. No.: US 2005/0091172 A1
(43) Pub. Date: Apr. 28, 2005

(54) Method and system for executing a transaction

(75) Inventors: Philip J. King, Murfreesboro, TN (US); Dennis J. Jones, Murfreesboro, TN (US); Sherry L. O'Rick, Mt. Juliet, TN (US)

Correspondence Address: John M. Vasuta, Esq.;Bridgestone Americans Holding, Inc., 1200 Firestone Parkway, Akron, OH, 44317, US

(73) Assignee: Bridgestone/Firestone North American Tire, LLC

(21) Appl. No.: 10/970,854

(22) Filed: Oct. 21, 2004

Related U.S. Application Data
(60) Provisional application No. 60/513,441, filed on Oct. 22, 2003.

(51) Int. Cl. G06F 17/60

(52) U.S. Cl. 705/64

(57) ABSTRACT

A method of executing a transaction associated with performance of an action involving a plurality of parties includes the steps of a first party initiating a transaction by contacting a designated call center through a secure portal and requesting performance of an action. Another step includes the call center querying a second party regarding predetermined preferences of the first party. Still another step includes one of the first party and the call center selecting a third party to perform the requested action. The selection being based at least in part upon the predetermined preferences. Yet another step includes the call center contacting the third party through the secure portal and arranging for performance of the requested action by the third party. Further steps include the third party obtaining a performance acknowledgement from the first party after performance of the requested action and transmitting the performance acknowledgment to the second party through the second party through the secure portal. A system for executing a method is also disclosed.

This application claims the benefit of U.S. provisional application Ser. No. 60/513,441, filed Oct. 22, 2003, which is incorporated herein by reference in its entirety.

The present invention relates broadly to the art of business transactions and, more particularly, to a method and system for executing a transaction involving three or more parties that is associated with the performance of an action.

### BACKGROUND

The present invention finds particular application in conjunction with repair services for motor vehicles and will be described herein with particular reference thereto. However, it is to be specifically understood that the present invention is equally applicable for use in the provision of other services and in association with other service industries. For example, a method and system of the present invention could be used in association with repair services that can be provided by any one of numerous service entities for computers under warranty from a manufacturer. As such, the invention of the present disclosure finds broad application in other areas of service and is not intended to be in any way limited to the applications discussed herein relating to the provision of vehicle repair services.

Motor vehicles, including passenger vehicles and cargo transport vehicles, are ubiquitous and provide many benefits to business and society in general. However, with such a volume of motor vehicles constantly traveling over the roadways, it is unavoidable that some vehicles will break down along the roadway and need on-site service or repair occurring on the roadside and away from a service or repair center. As such, vehicle repairs of many types are commonly performed along the roadside.

Until the relatively recent proliferation of wireless communication devices, contacting a vehicle repair center to repair a vehicle stranded along the roadside was an uncertain and sometimes dangerous process, which in most cases seemed to cause significant delay in the schedule of the vehicle operator. Even with the common use of wireless communication devices, the process of contacting a service center and arranging for repairs can still be a difficult and time-consuming process. Part of the problem rests with the typical unfamiliarity of the operator with regard to the service providers and contact information therefor in the geographic area of the breakdown. However, to assist in the process, individuals have historically relied upon automotive associations and professional transporters, or truckers, have often relied upon corporate assistance to coordinate and arrange for roadside vehicle repairs.

However, even though automotive associations and corporate service departments have access to contact information for service centers across the country, it remains difficult to select a suitable service center and arrange for timely repair of the vehicle. One reason for such difficulties is that the precise geographic location of the vehicle in need of service is often unknown. As such, a service center that is located a significant distance from the actual vehicle may be unknowingly contacted, thus adding to the delay in effecting repairs. Furthermore, to arrange for expeditious repair of the vehicle, it is often necessary to contact numerous service centers to find which of those service centers will have the best response time. Unfortunately, the service provider having the best response time may be outside the area that the person in the automotive association or corporate service center has selected, often intuitively, as the area having suitably close service centers. Further still, the service centers that are contacted may not have the necessary inventory, such as the proper tire size or type, for example, to properly service the vehicle. As such, other service centers must then be considered and the selection process repeated. The entire exercise can often be quite hit-or-miss with regard to finding a suitably responsive service provider that also has the proper inventory and/or equipment.

Another disadvantage of known arrangements is that the same are in many ways not conducive to the adoption of e-commerce enabled trading. That is, the present method of transacting the vehicle repairs includes the preparation and transmittance of numerous forms and other documents, as well as other papers detailing the financial aspects of the transaction. All of these documents are subject to being lost or prepared incorrectly. Furthermore there are significant costs associated with manual entry of the transactions into the associated systems of the various parties, and delays in entering, invoicing and receiving payment due to the transportation of the documents.

Still another disadvantage of known arrangements is that the same can be susceptible to fraudulent repairs and/or price gouging. While the assistance of an automotive association or a corporate service department in arranging for roadside repair services can help to reduce the engagement of unscrupulous service providers, the fact remains that once the service provider arrives at the service site, there is little to prevent unscrupulous tactics from being employed, such as the provider overstating the required repairs or claiming that the only available repair parts are those that are of higher performance or quality and, therefore, higher priced, than those that are necessary or desired for the then present repairs.

As such, it is believed desirable to develop a method and system for executing a transaction involving a plurality of parties, which is associated with performance of an action, such as a vehicle repair, for example, and which avoids or minimizes the problems and disadvantages of known service arrangements.

### SUMMARY

A method of executing a transaction associated with performance of an action involving a plurality of parties is provided and includes the steps of a first party initiating a transaction by contacting a designated call center through a secure portal and requesting performance of an action. Another step includes the call center querying a second party regarding predetermined preferences of the first party. Still another step includes one of the first party and the call center selecting a third party to perform the requested action. The selection being based at least in part upon the predetermined preferences. Yet another step includes the call center contacting the third party through the secure portal and arranging for performance of the requested action by the third party. Further steps include the third party obtaining a performance acknowledgement from the first party after performance of the requested action and transmitting the performance acknowledgment to the second party through the second party through the secure portal.

Another method of executing a transaction associated with performance of an action involving first, second and third parties is provided. The first party including an associated transporter and an associated transport administrator. The method including steps of the associated transporter of the first party initiating a transaction by contacting a designated call center through a secure portal and requesting performance of an action. Another step includes the call center obtaining data associated with a specific geographic location of the associated transporter. Still another step includes the call center querying a second party regarding predetermined preferences of the first party. Yet another step includes one of the associated transporter and the call center selecting a third party to perform the requested action. The selection being based, at least in part, on the specific geographic location of the associated transporter and the predetermined preferences of the first party. Further steps include one of the associated transporter and the call center contacting the associated transport administrator through the secure portal and requesting authorization for performance of the requested action by the selected third party. Upon receiving authorization from the associated transport administrator, further steps include the call center contacting the selected third party through the secure portal and arranging for performance of the requested action by the third party. Still other steps include the selected third party obtaining a performance acknowledgement from the associated transporter after performance of the requested action and transmitting the performance acknowledgment to the second party through the secure portal.

A further method of executing a transaction associated with performance of an action involving a plurality of parties is provided and includes steps of a first party initiating a transaction by contacting a designated call center through a secure portal and requesting performance of an action. Another step includes the call center obtaining data associated with a specific geographic location of the first party. Another step includes the call center querying a second party regarding predetermined preferences of the first party. Still another step includes the call center querying a plurality of potential third parties through the secure portal with regard to at least one of inventory, availability, response time and geographic location relative to the specific geographic location of the first party. Still another step includes one of the first party and the call center selecting a third party based upon individual responses from the plurality of potential third parties and the predetermined preferences. Further steps include the call center contacting the selected third party through the secure portal, requesting performance of the action by the third party and prompting the third party for a response regarding acceptance of the request for performance. Upon an affirmative response from the third party, a further step includes the call center arranging through said secure portal performance of the requested action by the third party. Yet further steps include the third party obtaining a performance acknowledgment from the first party after performance of the requested action and transmitting the performance acknowledgment to the second party through the secure portal.

Yet another method of executing a transaction associated with performance of an action involving first, second and third parties is provided. The first party including an associated transporter and an associated transport administrator. The third party including an associated servicer and an associated service administrator. The method including steps of the associated transporter of the first party initiating a transaction by contacting a designated call center through a secure portal and requesting performance of an action. Another step includes the call center obtaining data associated with a specific location of the associated transporter. Another step includes the call center querying a second party regarding predetermined preferences of the first party. Still another step includes the call center querying a plurality of potential third parties through said secure portal with regard to at least one of inventory, availability and response time. Yet another step includes the call center obtaining data associated with a geographic location of the associated servicer relative to the specific geographic location of the first party for one or more of the plurality of potential third parties. A further step includes the call center ranking the potential third parties based upon individual responses to the query as well as the geographic location of the associated servicer relative to the geographic location of the associated transporter. A further step includes one of the transporter, the call center and the associated transport administrator selecting a specific third party based upon the ranking of potential third parties. Still a further step includes the call center requesting authorization from the associated transport administrator through said secure portal for performance of the requested action by the selected third party. Upon receiving an affirmative response from the associated transport administrator through said secure portal, further steps include the call center contacting the selected third party through said secure portal and requesting performance of the action. Upon receiving an affirmative response from the third party through said secure portal, a further step includes the call center arranging performance of the action by the third party through said secure portal. Yet further steps include the selected third party obtaining a performance acknowledgment from the associated transport person after performance of the requested action and transmitting the performance acknowledgment to the second party through the secure portal.

Still another method of executing a transaction associated with the performance of an action involving a plurality of parties is provided and includes steps of a first party initiating communication with a call center through a secure portal and requesting performance of an action. Another step includes the call center querying a second party for performance preferences of the first party. Still another step includes the call center querying a plurality of potential third parties through the secure portal. A further step includes one or more of the plurality of potential third parties communicating information responsive to the query to the call center through the secure portal. Further steps include the call center selecting one third party from the plurality of potential third parties and arranging for performance of the requested action by the one third party through said secure portal. Still a further step includes the third party obtaining a performance acknowledgment from the first party after performance of the requested action. Yet a further step includes the third party communicating the performance acknowledgment to the second party through the secure portal.

A system for executing a transaction associated with performance of an action involving a plurality of parties is also provided and includes a secure portal having means for sending and receiving one of audio, video and data communications. The system also includes a call center in communication with the secure portal. The call center having means for directing communications into and out of the secure portal and computing means for processing the communications. The system also includes a database of predetermined preferences of a first party that is maintained by a second party. The system further includes means for communicating among the secure portal, the database, and at least one of the first, second and third parties. The system further includes means for the third party to electronically obtain a performance acknowledgment from the first party after performance of a requested action and means for transmitting the electronically obtained performance acknowledgment to the second party through the secure portal.

### BRIEF DESCRIPTION OF THE DRAWINGS

FIG. 1 is a schematic illustration of one system and communication arrangement for executing a transaction between a plurality of parties.

FIG. 2 is a flowchart illustrating steps of one method of executing a transaction in accordance with the present invention involving parties shown in FIG. 1.

FIG. 3 is a schematic illustration of an alternate system and communication arrangement for executing a transaction between a plurality of parties.

FIG. 4 is a flowchart illustrating steps of another method of executing a transaction in accordance with the present invention involving parties shown in FIG. 3.

FIG. 5 is a schematic illustration of another alternate system and communication arrangement for executing a transaction between a plurality of parties.

FIG. 6 is a flowchart illustrating steps of still another method of executing a transaction in accordance with the present invention involving parties shown in FIG. 5.

FIG. 7 is a schematic illustration of still another alternate system and communication arrangement for executing a transaction between a plurality of parties.

FIG. 8 is a schematic illustration of the system and communication arrangement of FIG. 7 shown with a selected third party.

FIG. 9 is a flowchart illustrating steps of yet another method of executing a transaction in accordance with the present invention involving parties shown in FIGS. 7 and 8.

FIG. 10 is a schematic illustration of yet another alternate system and communication arrangement for executing a transaction between a plurality of parties, with the parties having other systems associated therewith.

FIG. 11 is a schematic illustration of the system and communication arrangement of FIG. 10 showing the call center and secure portal integrally associated with one another.

FIGS. 12-14 taken together are a flowchart illustrating a further alternate method of executing a transaction in accordance with the present invention involving parties shown in FIGS. 10 and 11.

FIG. 15 is a schematic illustration of a system and communication arrangement such as that in FIGS. 10 and 11 showing the second party providing the call center and secure portal.

### DETAILED DESCRIPTION

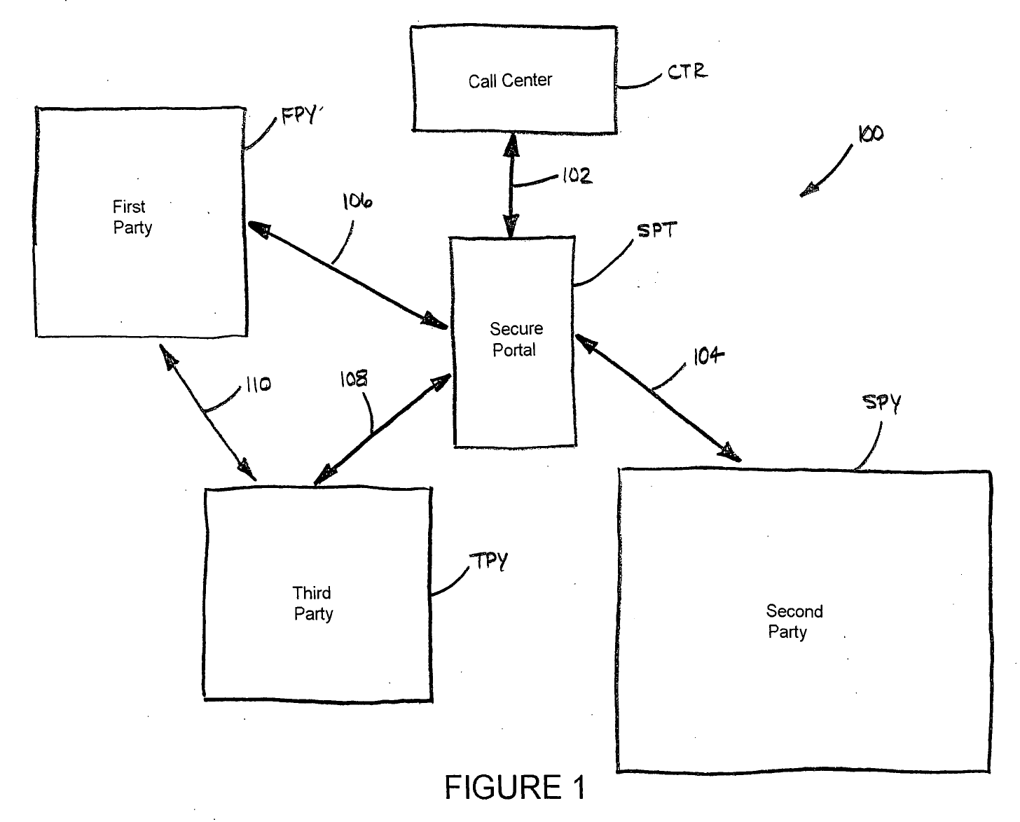

Turning now to the drawings, wherein the showings are for the purposes of illustrating preferred embodiments of the invention only, and not for the purposes of limiting the invention, FIG. 1 schematically illustrates a system and communications arrangement 100 that includes a secure portal SPT and a call center CTR in communication with the secure portal as indicated by arrow 102. A first party FPY is in communication with secure portal SPT as indicated by arrow 106. A second party SPY is in communication with the secure portal as indicated by arrow 104, and a third party TPY is in communication with secure portal SPT as shown by arrow 108. Additionally, first party FPY and third party TPY might, under certain circumstances to be discussed hereinafter, communicate with one another without utilizing the secure portal, as indicated by arrow 110.

It is to be understood from the outset that the arrows, such as arrows 102, 104, 106 and 108, for example, merely indicate lines of communication, and that communications along such lines can be made by or using any suitable technology, including but not limited to audio communications, video or image communications, and/or data communications. Examples of audio communications, such as those that may be sent over a telephone, radio or walkie-talkie, for example, include natural and/or synthesized voice communications as well as tone communications. Examples of video or image communications, such as those that may be sent over a video phone or camera phone, for example, include streaming video, video files, image files and/or other graphics files. Examples of data communications, such as those that may be sent using a computer (workstation, desktop, laptop and/or any other suitable computing device, for example), a portable digital assistant (such a pocket PC, PALM®, or other electronic handheld device, for example), and/or other text messaging devices (such as a text capable cellular telephone or BLACKBERRY® messaging devices, for example), for example, include any data in any form. (PALM is a registered trademark of Palm, Inc. and BLACKBERRY is a registered trademark of Research in Motion, Ltd.) Additionally, the communications, regardless of type, kind or format, can be transmitted to and from the secure portal in any suitable manner, including but not limited to land-line communications, wireless communications, satellite communications, internet communications and/or any other commercially available or otherwise known transmission method. Furthermore, communications between two or more parties may, under certain circumstances, also be made in person, such as verbal communications or written communications, for example. One instance where such face-to-face communications may occur is between first party FPY and third party TPY when the parties are in geographic proximity to one another, such as where the operator of a service vehicle arrives at a broken down vehicle to effect repairs and speaks with the operator of the broken down vehicle, for example. Such an instance is indicated in FIG. 1 by arrow 110. As such, it should be appreciated that the spacing between the various parties shown in the drawing figures do not necessarily represent the relative geographic position of the respective parties.

Secure portal SPT is a communication hub, such as are well known by those skilled in such art, and is capable of securely receiving and transmitting communications of any presently commercially available or otherwise known type, kind or format, such as audio communications, video communications and/or data communications, as discussed above. Additionally, the secure portal is preferably adapted to translate, convert or otherwise connect between parties using communications of different formats. For example, one party can use text messaging to communicate through said secure portal with another party using a cellular telephone. The secure portal preferably converts between text messages and voice communications to ensure that each party receives the communications from the other. It will be appreciated, however, that secure portal SPT is not intended to be limited to communications between just two parties, but rather that a significant number of multi-party communications can preferably be ongoing at one time.

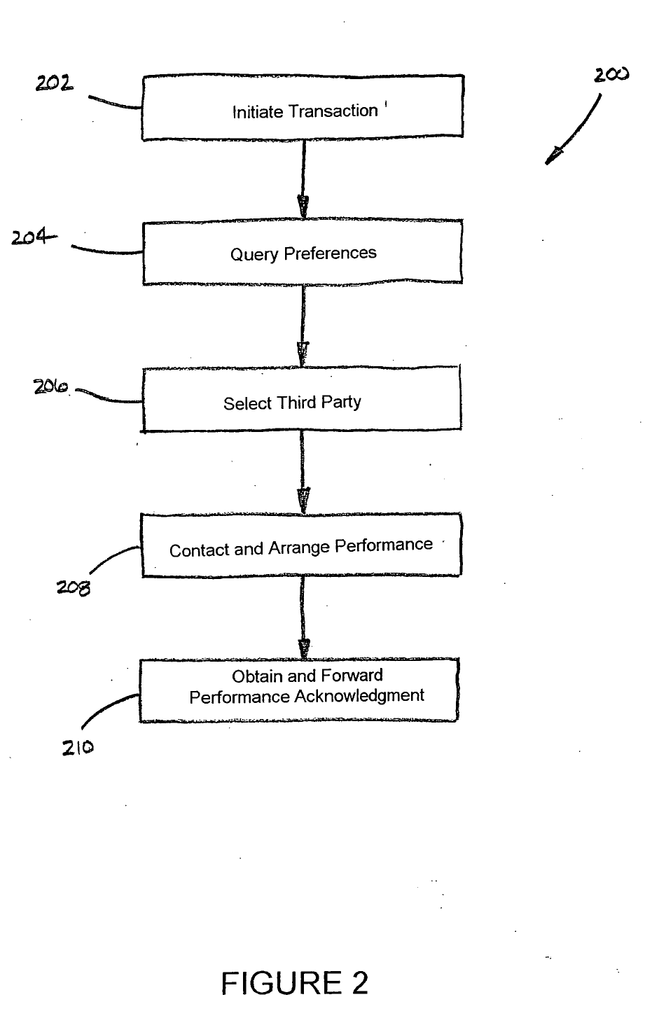

FIG. 2 illustrates steps in one method 200 of executing a transaction associated with the performance of an action, according to the present invention. The transaction is between a plurality of parties, such as those shown in FIG. 1. Method 200 includes a step 202 of a first party FPY to the transaction initiating the same by contacting a designated call center CTR through a secure portal SPT, and requesting performance of an action. The first party can contact the secure portal using any suitable communication type, kind or format, as discussed above. In another step 204, call center CTR queries a second party SPY regarding predetermined preferences of first party FPY. Preferably, the second party maintains a database of a plurality of potential first parties and the associated preferences thereof. One instance of where such a database might be maintained is where the first party has business relationship with the second party. For example, if the second party is a manufacturer and the first party is a pre-existing customer of the second party. In another step 206, one of the first party and the call center, or both in collaboration, selects a third party TPY to perform the requested action. The selection of the third party being based at least in party on the predetermined preferences of the first party. In still another step 208, call center CTR contacts the selected third party through secure portal SPT and arranges for performance of the requested action by the third party. In further steps 210, the third party obtains a performance acknowledgment from first party FPY after performance of the requested action, and the third party transmits the performance acknowledgment to at least one of the first and second parties through the secure portal. The performance acknowledgment is preferably acts as a showing from the first party that the third party performed or otherwise completed the requested action. The performance acknowledgment can take any suitable form or be of any suitable type or manner of showing. For example, the performance acknowledgment could be a hand-signed paper document. Preferably, however, the performance acknowledgment is an electronically captured showing that can be communicated through the secure portal with a minimal amount of further processing. Examples of suitable steps for electronically capturing a performance acknowledgment include reading a data or smart card of the first party, recording a signature of the first party on an electronic tablet, recording a voice print from the first party and/or scanning a biological feature of the first party.

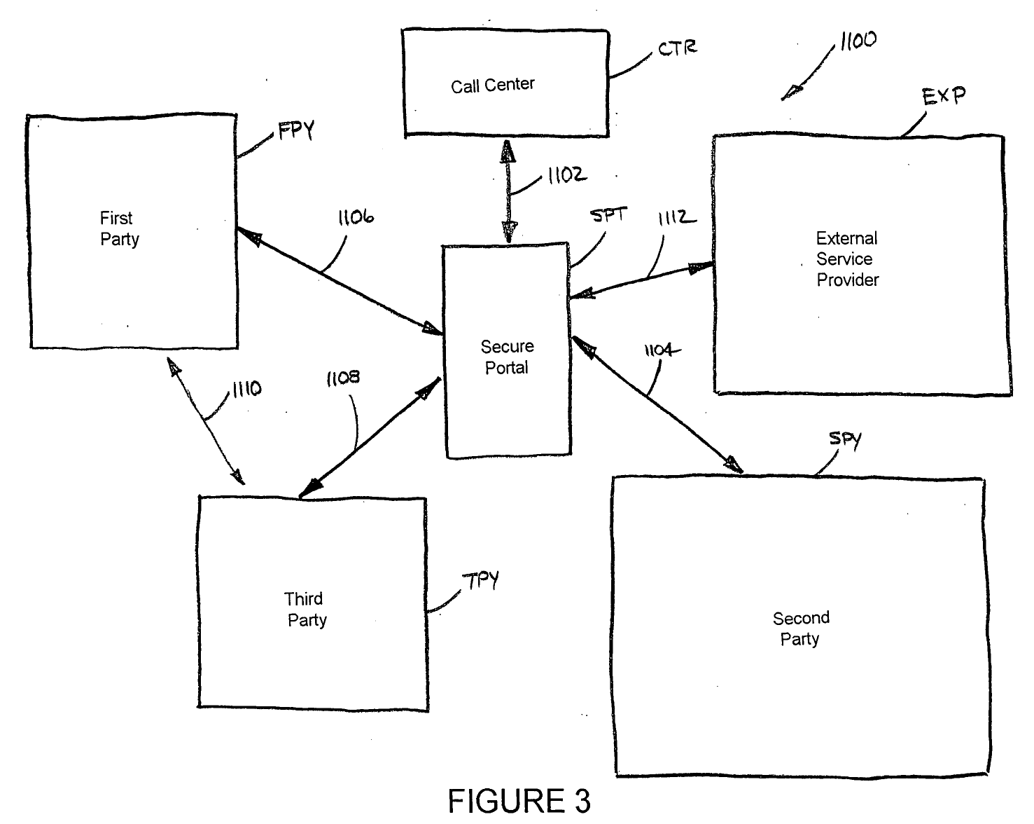

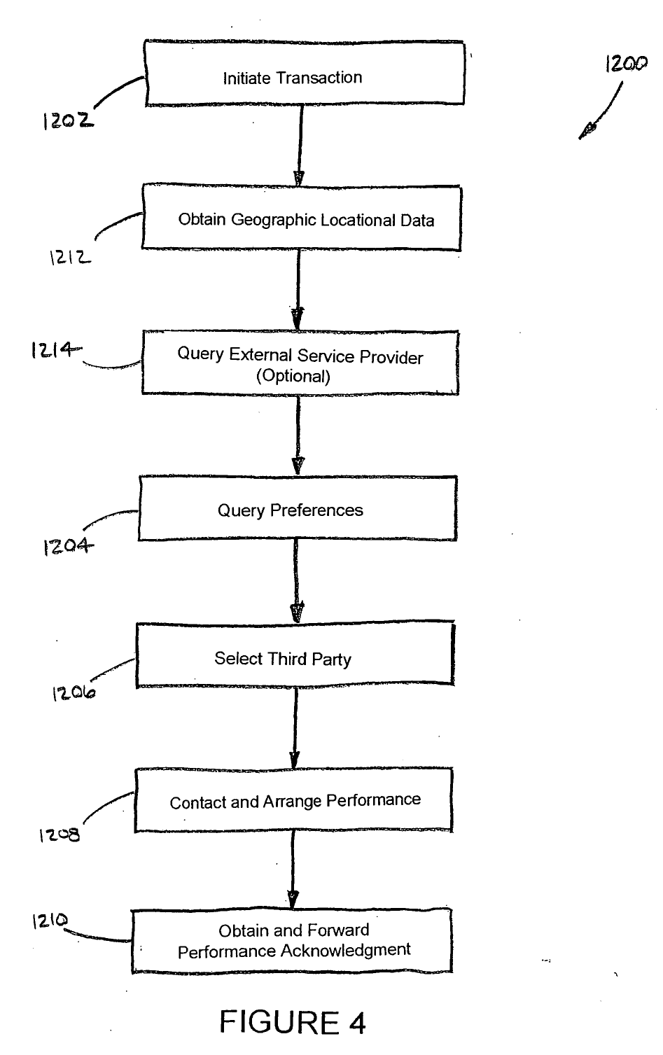

FIG. 3 schematically illustrates an alternate system and communications arrangement 1100 for executing a transaction between a plurality of parties. FIG. 4 illustrates steps in another method 1200 of executing a transaction associated with the performance of an action, according to the present invention. It will be appreciated that system and communications arrangement 1100 is substantially similar to system and communications arrangement 100 shown in FIG. 1, and method 1200 is substantially similar to method 200 shown in FIG. 2. Unless otherwise indicated, the items in FIGS. 3 and 4 correspond to those respectively illustrated in and discussed with regard to FIGS. 1 and 2. However, the items in FIGS. 3 and 4 include reference numerals incremented by 1000. For example, arrow 102 in FIG. 1 corresponds to arrow 1102 in FIG. 3, and step 204 in FIG. 2 corresponds to step 1204 in FIG. 4. Items shown in and described with regard to one drawing figure but having no counterpart in one or more of the other figures will be distinctly pointed out and discussed.

FIG. 3 includes an external service provider EXP that is not shown in FIG. 1. External service provider EXP is in communication with secure portal SPT as indicated by arrow 1112. External service provider EXP can provide any kind or type of service that is useful or desired by one or more of the parties, or that assists the call center in any way, such as with communications, operations and/or system maintenance, for example. Preferably, external service providers can and/or will provide information, data, support and/or any other manner of assistance that is desired by one or more of the parties, the call center and/or the system generally.

Referring now to FIG. 4, another method 1200 of executing a transaction associated with the performance of an action, according to the present invention, is provided. Method 1200 includes a step 1212 of obtaining the geographic location or data associated with the geographic location of one of the parties, such as first party FPY, for example. This can be done in any suitable manner, such as asking the first party where he or she is, for example. Another manner of obtaining the geographic location or data associated therewith includes a step 1214 of querying an external service provider EXP that is providing the communication service to the first party as to the location of the first party. As one example, external service provider EXP could be a cellular service provider for first party FPY. Upon first party FPY contacting call center CTR through secure portal SPT via a cellular telephone, call center CTR queries the cellular telephone for a password or other code. Upon receiving the password from the cellular telephone, call center CTR queries provider EXP along arrow 1112 for the longitude and latitude of the cellular telephone of first party FPY. In certain cases, it may be necessary for call center CTR to supply provider EXP with the password or other code before the locational data will be provided. As another example, external service provider EXP could be a provider of telephone services including pay phones. Upon obtaining the pay phone number from which a first party FPY is calling, call center CTR could query the external service provider for the location of that specific pay phone and thereby determine the location of the first party. It is to be specifically understood, however, that the foregoing are simply examples of suitable external service providers and the interactions therewith, and that any suitable and/or desired external service providers and number thereof can be used without departing from the principles of the present invention. As such, external service providers that are other than communication service providers can be used as well. Such other service providers can include financial service providers, for approving credit card charges, for example. Other service providers could be emergency service provider, such as police, fire or emergency medical service providers, for example.

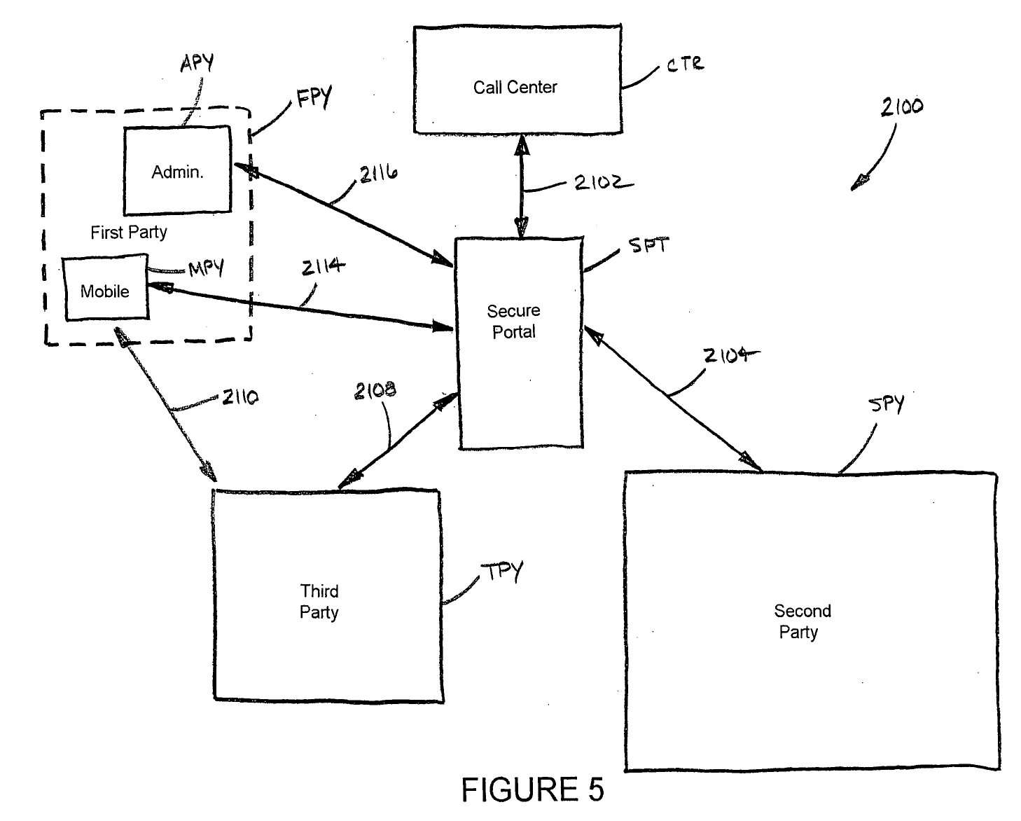

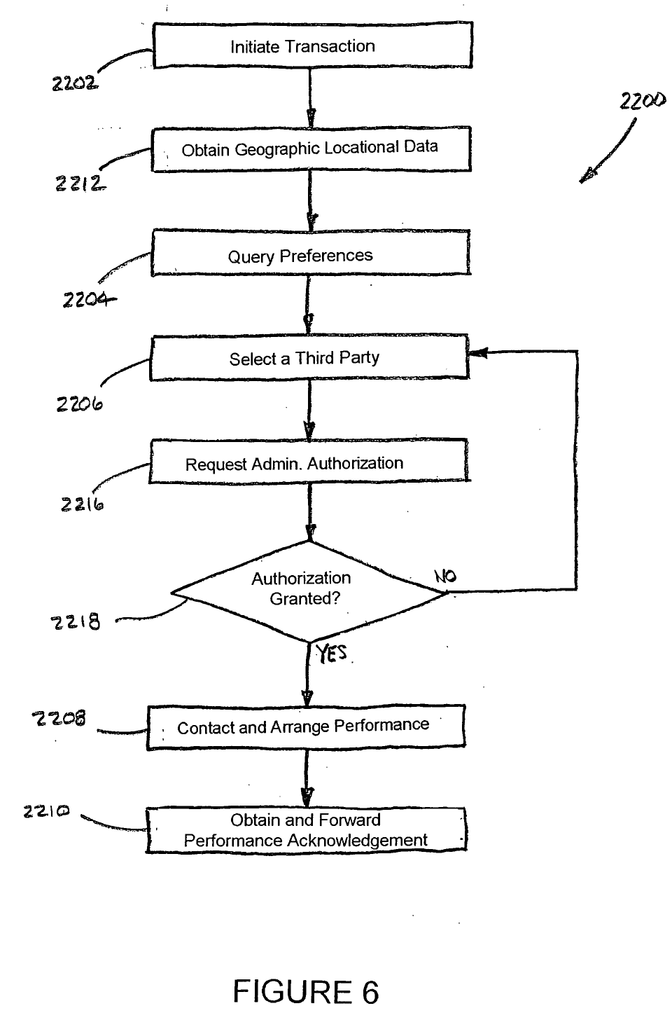

FIG. 5 schematically illustrates another alternate system and communications arrangement 2100 for executing a transaction between a plurality of parties. FIG. 6 illustrates steps in still another method 2200 of executing a transaction associated with the performance of an action, according to the present invention. It will be appreciated that system and communications arrangement 2100 is substantially similar to system and communications arrangement 100 shown in FIG. 1, and method 2200 is substantially similar to method 200 shown in FIG. 2. Unless otherwise indicated, the items in FIGS. 5 and 6 correspond to those respectively illustrated in and discussed with regard to FIGS. 1 and 2. However, the items in FIGS. 5 and 6 include reference numerals incremented by 2000. For example, arrow 102 in FIG. 1 corresponds to arrow 2102 in FIG. 5, and step 204 in FIG. 2 corresponds to step 2204 in FIG. 6. Items shown in and described with regard to one drawing figure but having no counterpart in one or more of the other figures will be distinctly pointed out and discussed.

In FIG. 5, first party FPY includes two parties, an associated transporter or other mobile party MPY and an associated transport administrator or other administrative party APY. Arrow 106 in FIG. 1 is not shown in FIG. 5. Rather, separate and distinct lines of communication between mobile party MPY and secure portal SPT and between administrative party APY and secure portal SPT are indicated by arrows 2114 and 2116, respectively. It will be appreciated that mobile party MPY can be any mobile vehicle operator associated with the first party, such as a truck driver that is an agent, employee or a person otherwise associated with the first party. It will be further appreciated that administrative party APY can be any person, such as an agent or employee of the first party, or system empowered authorize the performance of an action associated with the mobile party. In many situations, mobile party MPY and administrative party APY will be in different locations. For example, first party FPY might own or otherwise have an association with a plurality of vehicles, such as cars or trucks, for example. Mobile party MPY might be an operator, such as a truck driver, for example, of one of the plurality of vehicles and is traveling along a roadway; while administrative party APY is located at a central office, such as a dispatch terminal, for example. Other examples of mobile and administrative parties could include a child and a parent, a person who has rented a car and the associated rental car company, and/or a taxi cab operator and an associated taxi cab company.

FIG. 6 illustrates steps in still another method 2200 of executing a transaction associated with the performance of an action, according to the present invention. Method 2200 also includes step 1212 (and can optionally include step 1214) from method 1200 in FIG. 4. Step 1212 is shown as step 2212 in FIG. 6. After selecting a third party to perform the requested action in step 2206, method 2200 includes a step 2216 of one of call center CTR and the associated transporter or mobile party MPY contacts administrative party APY and requests authorization for performance of the action by the selected third party. Preferably, administrative party APY is contacted and responds via secure portal SPT. Based upon the response of the administrative party, a decision is made in step 2218. Upon receiving an affirmative response the method continues with step 2208 as discussed previously. Upon receiving a negative response, method 2200 returns to step 2206 so that another third party can be selected, and a subsequent request for authorization is made in step 2216 based upon the newly selected third party. Steps 2206 and 2216 are repeated until an affirmative response is received at decision step 2218 to the request in step 2216.

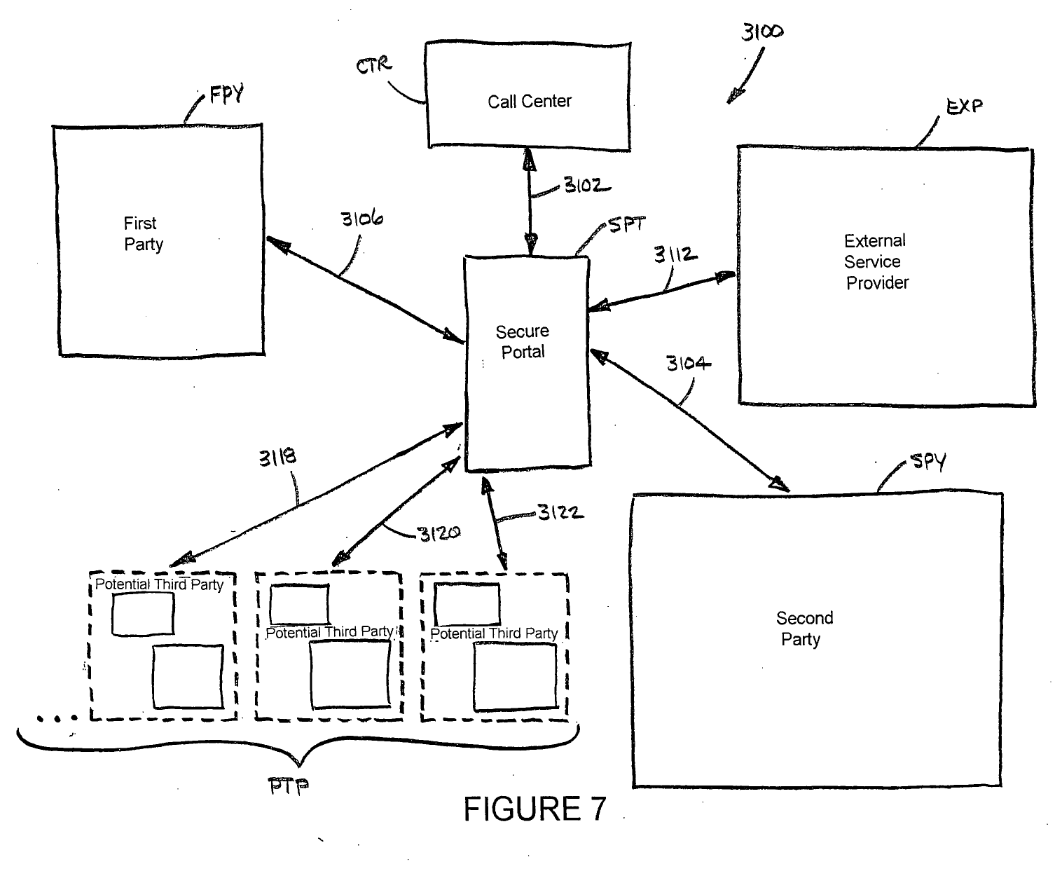

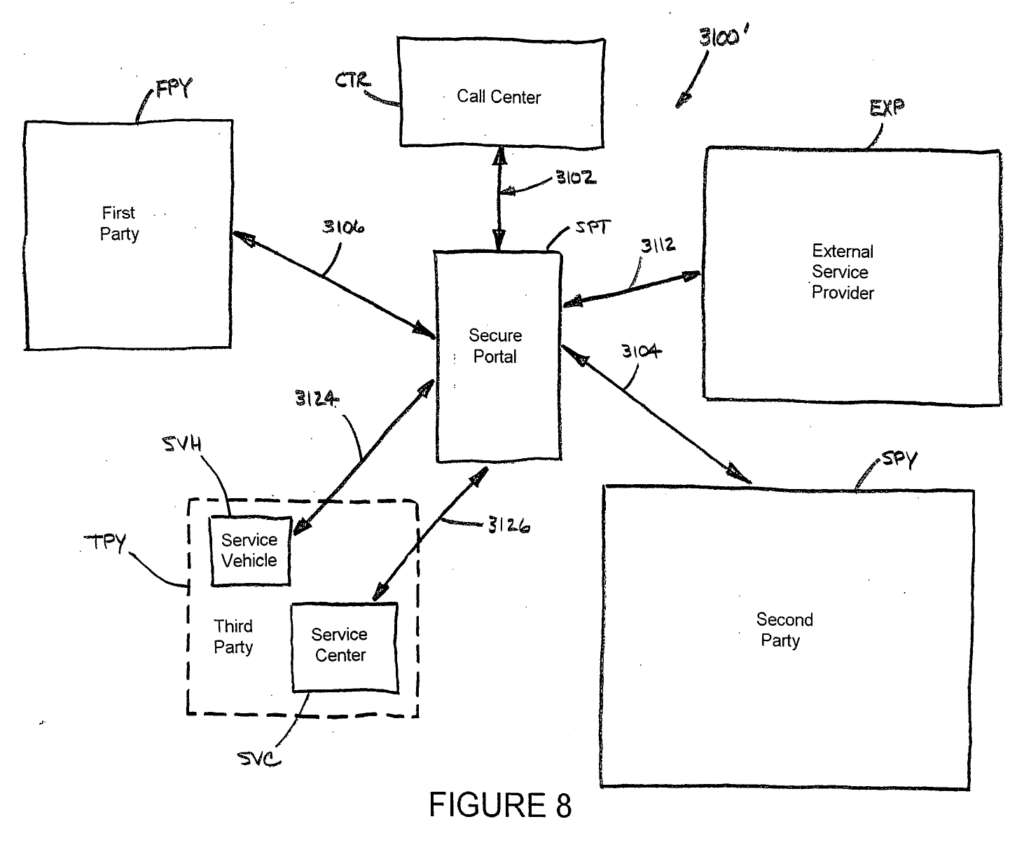

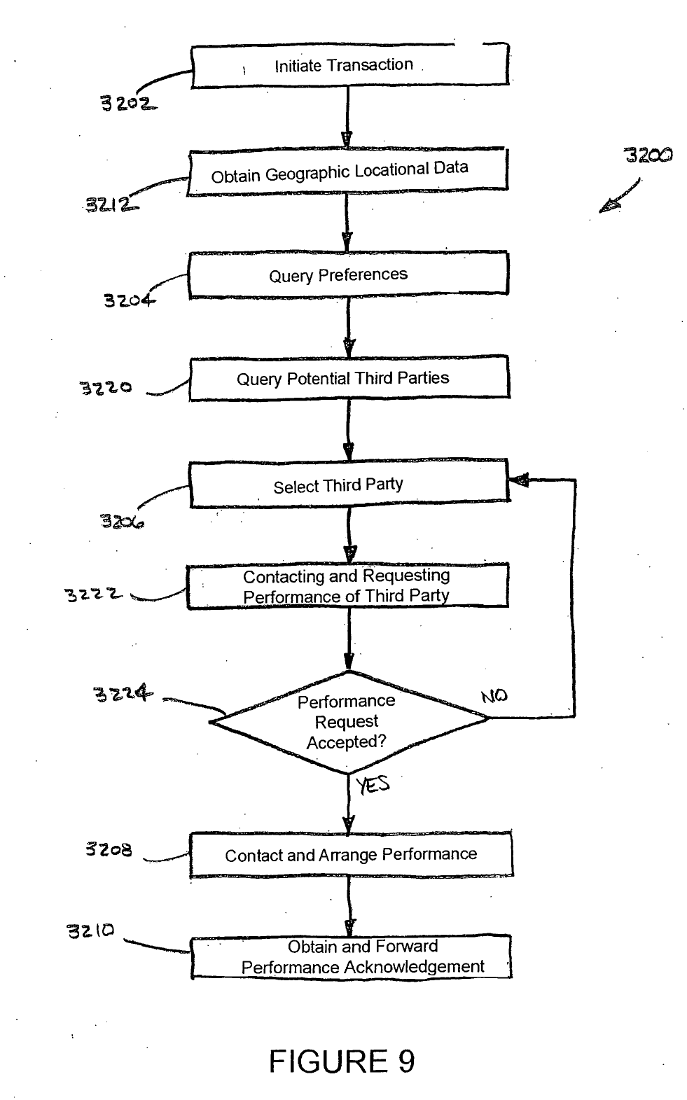

FIGS. 7 and 8 schematically illustrate still another alternate system and communications arrangement 3100 and 3100′, respectively, for executing a transaction between a plurality of parties. FIG. 9 illustrates steps in yet another method 3200 of executing a transaction associated with the performance of an action, according to the present invention. It will be appreciated that system and communications arrangement 3100 and 3100′ shown in FIGS. 7 and 8 is substantially similar to system and communications arrangement 1100 shown in FIG. 3, and method 3200 is substantially similar to method 1200 shown in FIG. 4. Unless otherwise indicated, the items in FIGS. 7 and 8, and FIG. 9 correspond to those respectively illustrated in and discussed with regard to FIGS. 3 and 4. However, the items in FIGS. 7, 8 and 9 include reference numerals incremented by 2000. For example, arrow 1102 in FIG. 3 corresponds to arrow 3102 in FIGS. 7 and 8, and step 1204 in FIG. 2 corresponds to step 3204 in FIG. 9. Items shown in and described with regard to one drawing figure but having no counterpart in one or more of the other figures will be distinctly pointed out and discussed.

In FIG. 7, third party TPY as well as arrows 1108 and 1110 (FIG. 3) are replaced by a plurality of potential third parties PTP each in communication with secure portal SPT as indicated by arrows 3118, 3120 and 3122. It will be appreciated that any suitable number of potential third parties can be involved. In FIG. 8, a third party TPY has been selected from the plurality of potential third parties in FIG. 7. Third party TPY in FIG. 8 includes an associated servicer, such as an operator of a service vehicle SVH, and an associated service administrator, such as a person located at an associated service center SVC, for example. Service vehicle SVH and/or the operator thereof are preferably equipped with suitable communications equipment to communicate with the secure portal as indicated by arrow 3124. Similarly, service center SVC and/or an administrator located thereat is in communication with the secure portal, as indicated by arrow 3126.

FIG. 9 illustrates steps in yet another method 3200 of executing a transaction associated with the performance of an action, according to the present invention. Method 3200 includes a step 3220 of querying a plurality of potential third parties, such as parties PTP in FIG. 7, for example, with regard to one or more factors such as inventory on-hand, availability to perform services, response time for initiation of performance, and/or geographic location of either a service center or an associated service vehicle to the specific geographic location of first party FPY, for example. In step 3206, based at least in part upon the responses from the potential third parties, a third party TPY (FIG. 8) is selected. In step 3222, after selecting the third party, one of the first party and the call center contacting the selected third party and requesting performance of the action. The selected third party thereafter responds to the request for action as indicated in decision block 3224. Upon an affirmative response, the call center arranges for performance as indicated in step 3208. Upon a negative response, method 3200 returns to step 3206 and one of the call center and/or the first party selects another, different third party and thereafter requests performance thereby, as shown in step 3222. This process repeats until an affirmative response is received in decision step 3224.

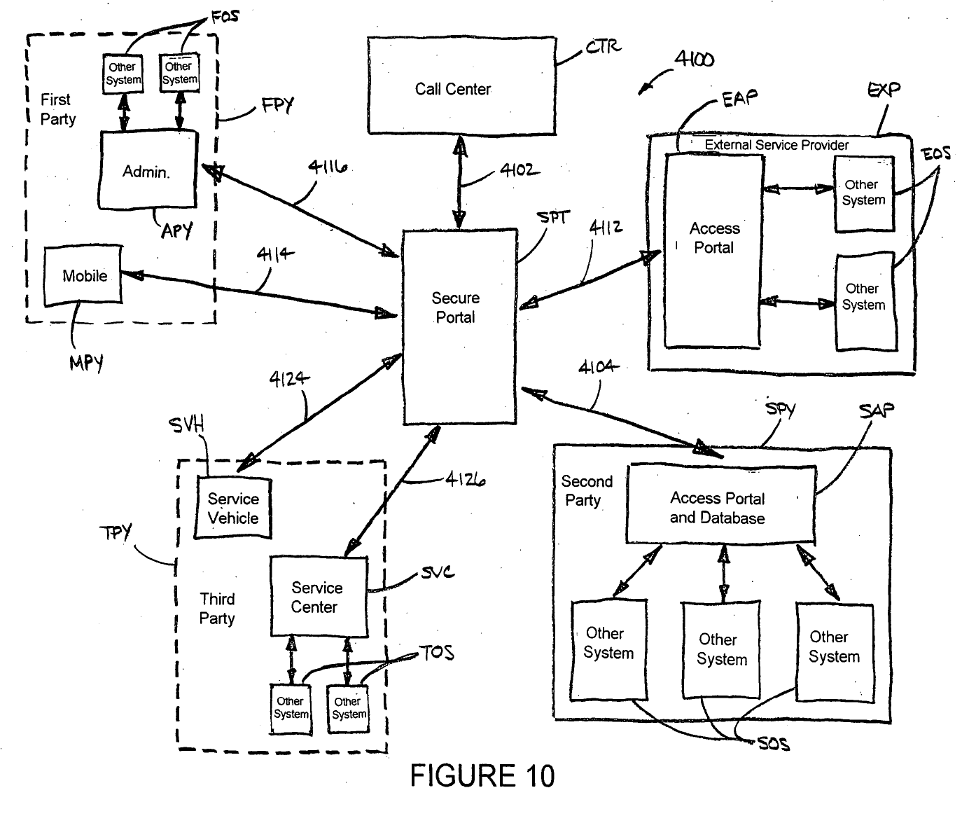

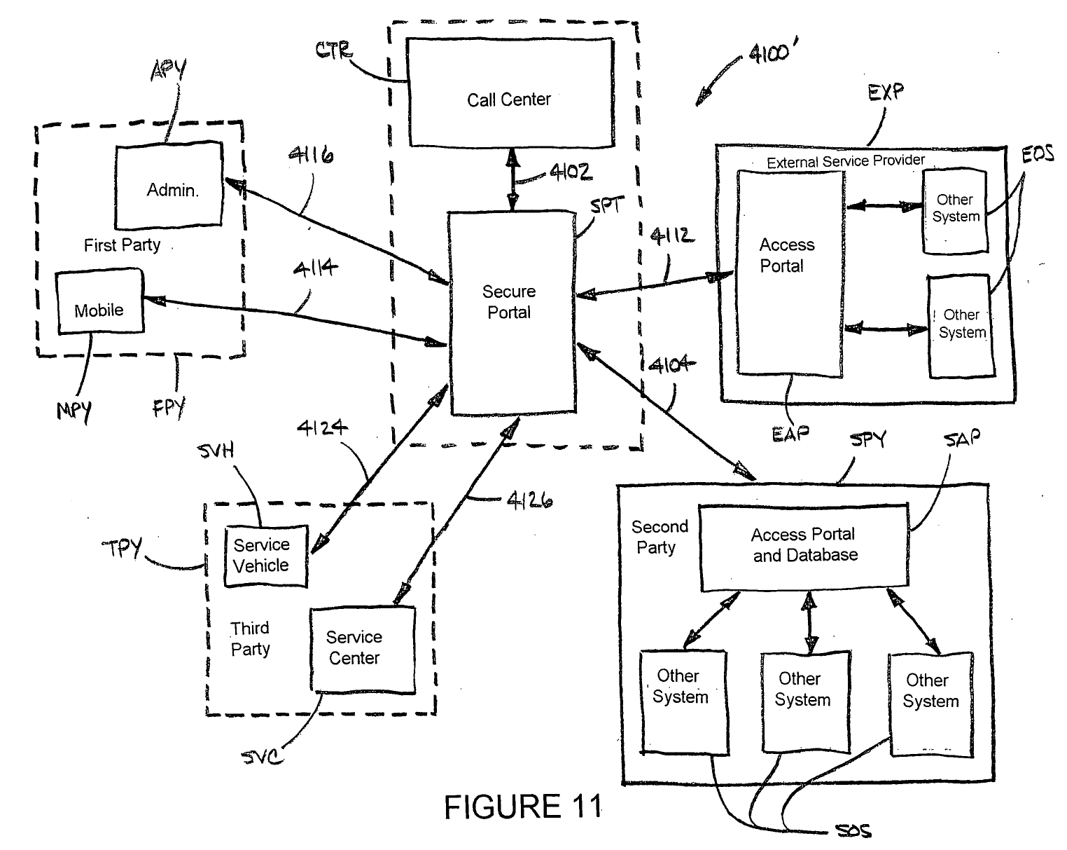

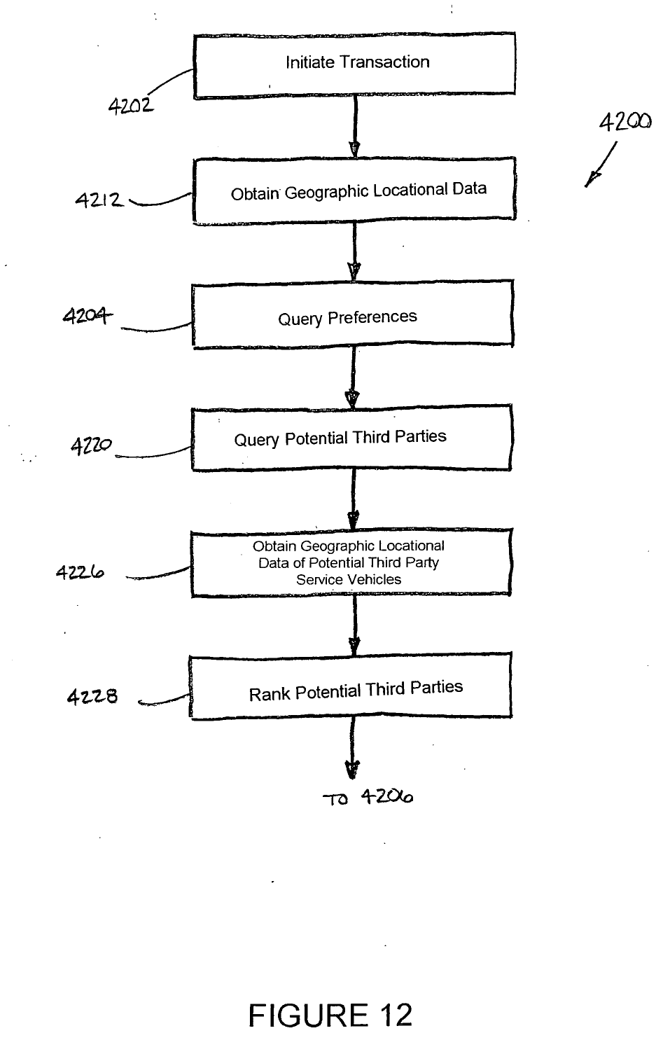

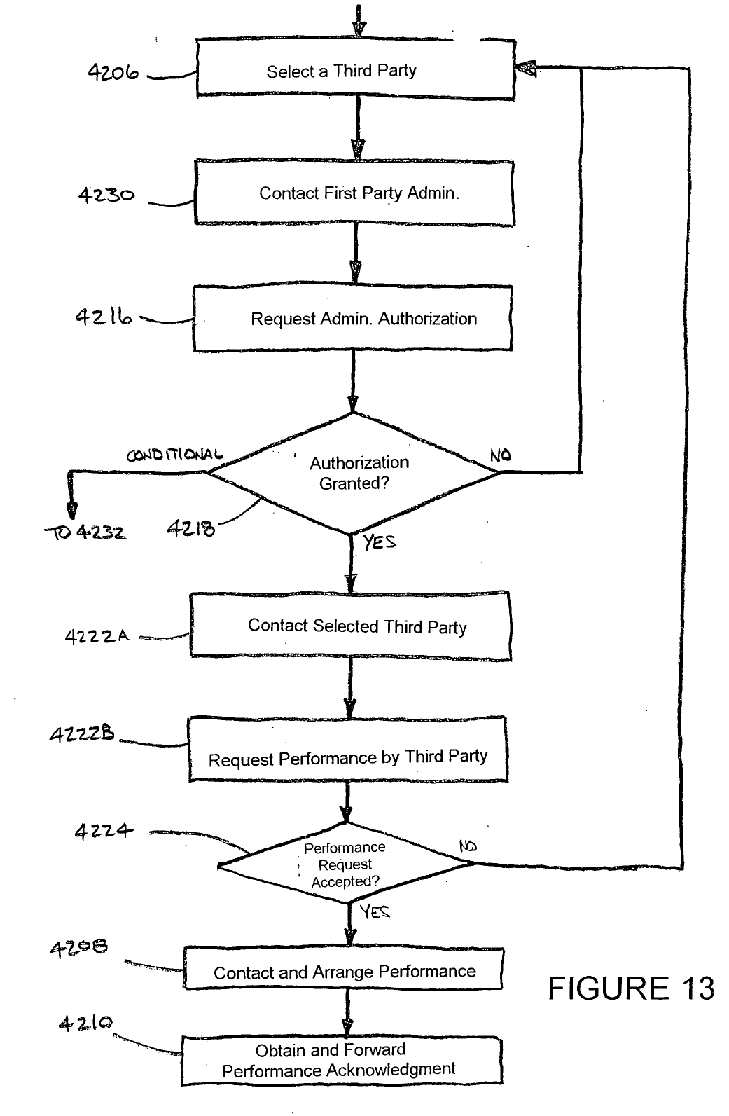

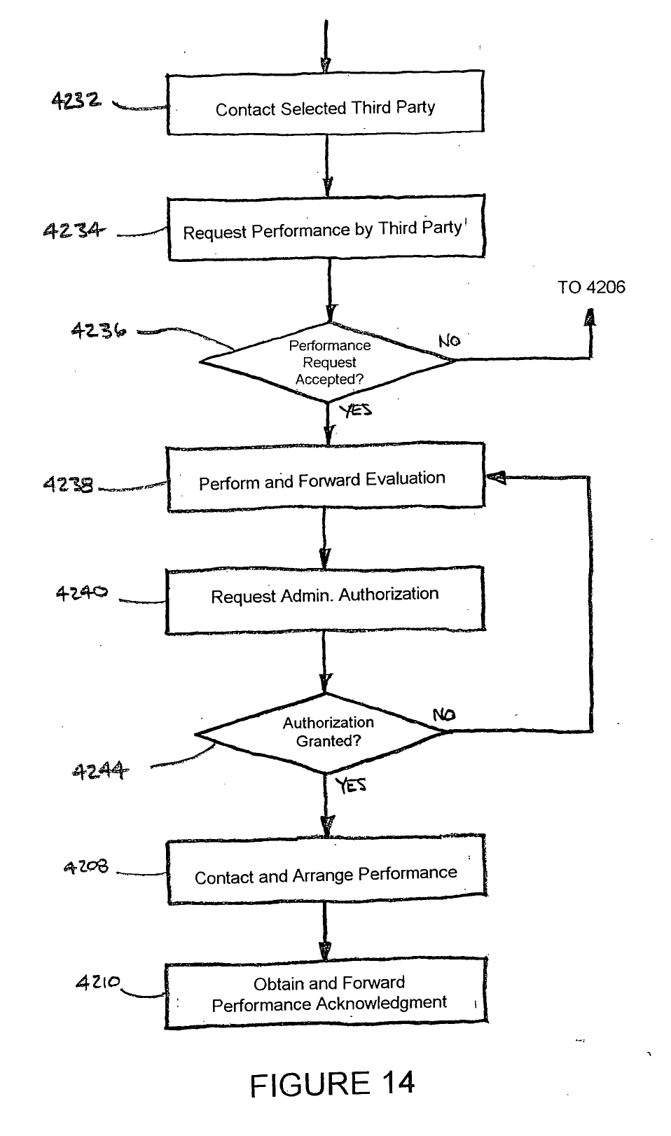

FIGS. 10 and 11 schematically illustrate yet another alternate system and communications arrangement 4100 and 4100′, respectively, for executing a transaction between a plurality of parties. FIGS. 12-14, taken together, illustrates steps in a further alternate method 4200 of executing a transaction associated with the performance of an action, according to the present invention. It will be appreciated that system and communications arrangement 4100 and 4100′ shown in FIGS. 10 and 11 is substantially similar to system and communications arrangement 3100′ shown in FIG. 8, and method 4200 is substantially similar to method 3200 shown in FIG. 9. Unless otherwise indicated, the items in FIGS. 10 and 11, and FIGS. 12-14 correspond to those respectively illustrated in and discussed with regard to FIGS. 8 and 9. However, the items in FIGS. 10-14 include reference numerals incremented by 1000. For example, arrow 3102 in FIG. 8 corresponds to arrow 4102 in FIGS. 10 and 11, and step 3204 in FIG. 9 corresponds to step 4204 in FIG. 12. Items shown in and described with regard to one drawing figure but having no counterpart in one or more of the other figures will be distinctly pointed out and discussed.

System and communications arrangement 4100 in FIG. 10 shows first party FPY have one or more associated other systems FOS in communication with administrative party APY. Additionally, second party SPY, third party TPY and external service provider EXP each have one or more associated other systems SOS, TOS and EOS, respectively. Second party SPY and provider EXP also have an access portal, respectively indicated as SAP and EAP in FIG. 10, with the respective systems SOS and EOS in communication therewith. Systems TOS of third party TPY are in communication with service center SVC. It will be appreciated that such associated other systems are optional, and generally do not form a part of the present inventive method and system. However, communications to and from such systems, such as electronic documents, work orders, delivery requirements, performance acknowledgments, invoices and account credits, for example, can be disseminated via the secure portal as another step in the present inventive method.

Preferably, access portal SAP of the second party is in communication with a database containing performance preferences of a plurality of potential first parties. It will be appreciated, however, that the access portal and database might not be integrally formed or even be in geographic proximity to one another. Access portals, such as portals SAP and EAP, for example, are common and generally well known by those of skill in the art. The database can maintain performance preferences for each of the plurality of potential third parties, such as product specifications, service criteria, criteria for selection of third parties, financial and/or account information, for example, in any suitable form. In one suitable form, the preferences could structured as a series of rules, with each parties responses to the rules stored in the database.

In FIG. 11, call center CTR and secure portal SPT are shown in dashed lines. It is to be understood that the dashed lines in this and other drawing figures are indicative of a common association but not necessarily of a geographic proximity. As such, in FIG. 11 the call center and the secure portal are shown as being commonly operated and/or maintained. In other systems and/or methods, the call center and secure portal might not have such a common association. For example, the second party could provide and maintain the call center with the secure portal being provided and maintained by another party, such as an external service provider or an outside contractor specifically retained by one of the parties to provide and maintain the secure portal, for example.

Turning now to FIGS. 12-14, method 4200 includes a step 4226 of obtaining the geographic location or data pertaining thereto for one or more of the plurality of potential third parties. Method 4200 also includes a step 4228 of ranking the potential third parties based at least in part on the responses to the queries in step 4220 and the relative position of the potential third parties to that of the first party determined in step 4228. After selecting a third party in step 4206, administrative party APY of first party FPY is contacted through secure portal SPY in step 4230. In another step 4216, a request is made for administrative authorization for the selected third party to perform the requested action. Upon receiving an affirmative response from administrative party APY, selected third party TPY is contacted in step 4222A and performance is requested in step 4222B. Upon receiving an affirmative response from selected third party TPY, arrangements for performance are made as indicated in step 4208. Upon receiving a negative response at decision block 4224 from the selected third party, method 4200 returns to step 4206 and another third party TPY′ is selected. Steps 4230, 4216, 4218, 4222A and 4222B are repeated until an affirmative response is received from third party TPY′ or a subsequently selected third party. Upon receiving a negative response from administrative party APY at decision block 4218 in either the first or any repetitions of the foregoing steps, method 4200 returns to step 4206 to select another, different third party. Steps 4206, 4230 and 4216 are repeated until an affirmative response is received from administrative party APY.

However, under certain condition, administrative party APY can give a conditional affirmative response in decision block 4218. In which case, method 4200 proceeds with a step 4232 by contacting the selected third party and requesting performance thereby in step 4234. It will be appreciated that steps 4232 and 4234 are substantially identical to steps 4222A and 4222B discussed hereinbefore. If the request for performance is declined by the selected third party in decision block 4236, method 4200 returns to step 4206 for selection of another, different third party and the steps thereafter are repeated as discussed above. Upon an acceptance by the selected third party in decision block 4236, a step 4238 of the selected third party performing an evaluation of the services to be provided is completed and the evaluation submitted to one of the parties, such as administrative party APY, for example, for approval of the service performance. In another step 4240, that is substantially similar to step 4216, a request is made to the administrative party for performance of the requested services based, at least in part, on the evaluation from the third party. Upon receiving a negative response from the administrative party in decision block 4244, the method returns to step 4238 for further evaluation and repeated submission of the evaluation until an affirmative response is received. Upon receiving an affirmative response in decision block 4244, method 4200 proceeds with steps 4208 and 4210 as discuss hereinbefore.

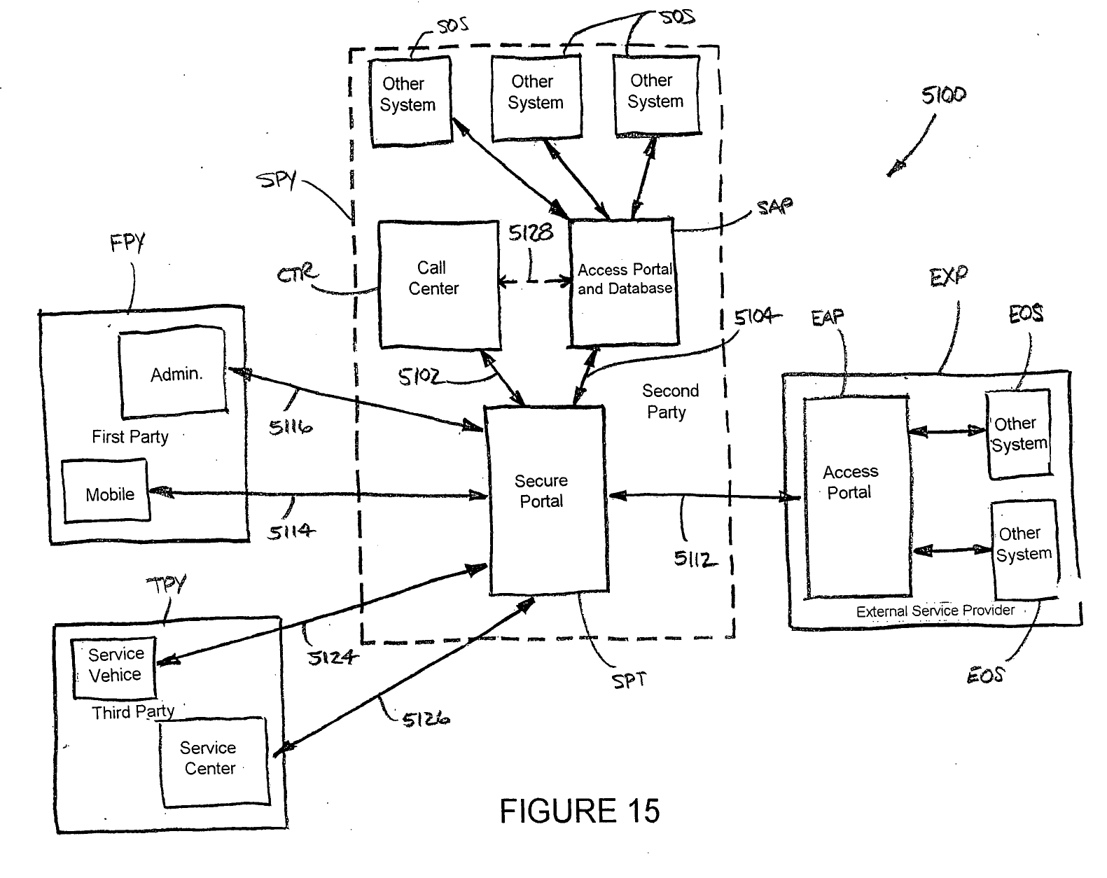

FIG. 15 illustrates another system and communications arrangement 5100. It will be appreciated that arrangement 5100 is substantially similar to that shown in and described with regard to FIGS. 10 and 11. However, the items in FIG. 15 include reference numerals incremented by 1000. In arrangement 5100, call-center CRT and secure portal SPT are commonly associated with second party SPY, as shown by the dashed lines. As indicated by arrow 5128, call center and access portal SAP can optionally be in communication with one another without connecting through secure portal SPT. Furthermore, it will be appreciated, as discussed hereinbefore, that the dashed line indicates that the various parts of second party SPY need not be in geographic proximity. But rather that these parts are commonly associated with one another.

Presently known and commercially available systems are commonly used in tracking the geographic location of vehicles as the same travel over the open road. These systems permit an associated administrator to monitor the position of each of the vehicles of an associated fleet in a substantially real-time manner. Typically, each vehicle in the fleet is outfitted with a suitable communication device, such as a global positioning device, for example, which is in turn interfaced with such a known system. These known systems, however, generally do not provide the associated administrator with any additional information, such as information regarding the status, condition or operation of the vehicle, for example.

A method and system in accordance with the present invention can also include technologies such as those used in the known systems discussed above or such a system could be provided by an external service provider. In either case, the data and information from such technology or system could be assimilated into a method and system in accordance with the present invention as an alternate step method of determining the geographic location of the first and/or third parties, especially mobile party MPY of first party FPY and/or service vehicle SVH of third party TPY.

In addition to the uses discussed hereinbefore, it will be appreciated that the present method and system can also be utilized in other ways and by other parties. For example, an administrative party, such as administrator APY of first party FPY and/or a person located at a service center SVC of third party TPY, for example, can utilize the secure portal to track and monitor the geographic location and operating status of all of the vehicles in an associated fleet. Additionally, where a vehicle is not operational, the administrative party can also acquire information such as repair details and costs, estimated repair time, the identity of the third party service provider, the current location of the service vehicle and a variety of other details for that vehicle.

As an example, where the operator of a vehicle initiates a request for repair of a vehicle tire and the preferences and/or other associated rules for determining an appropriate third party to perform the service do not require input or approval from the first party administrator, the same will often be unaware of the action being performed. However, the first party administrator can utilize the system, such as by using a graphical interface, for example, to inquire as to the status of any associated vehicle.

In continuing the present example, the first party administrator is able to access information above and beyond his/her level of involvement with the vehicle and/or the repairs thereon. For example, the first party administrator could ascertain the geographic location of the vehicle, the operating status thereof, what performance has been requested (tire repair, engine repair, etc.), the estimated time for completion of the requested repairs, the third party solicited to perform the repairs, the associated costs of the repairs and the location of the service vehicle of the third party. Additionally, the first party administrator could use the secure portal to initiate communications with any of the involved parties.

Similarly, an administrator of the third party could utilize the present system to monitor each of the associated service vehicles. In this way, the third party administrator could ascertain the geographic location of a service vehicle, the inventory and/or workload of the service vehicle, the details of the present repair request, and a variety of other information, for example. Additionally, the third party administrator could use the secure portal to initiate communications with any of the involved parties. In short, the present system can by use to aggregate all of the details of the associated parties in any desired manner and provide the details to an associated party without out the party being directly involved in the transaction.

While the invention has been described with reference to the preferred embodiments and method steps, and considerable emphasis has been placed herein on the system and communications between the parties discussed, it will be appreciated that other systems and methods of the invention can be made and that many changes can be made in those illustrated and described herein without departing from the principles of the invention. Obviously, modifications and alterations will occur to others upon reading and understanding the preceding detailed description. Accordingly, it is to be distinctly understood that the foregoing descriptive matter is to be interpreted merely as illustrative of the present invention and not as a limitation. As such, it is intended that the invention be-construed as including all such modifications and alterations insofar as they come within the scope of the appended claims and any equivalents thereof.

1. A method of executing a transaction associated with performance of an action involving a plurality of parties, said method comprising the steps of:
a) a first party initiating a transaction by contacting a designated call center through a secure portal and requesting performance of an action;
b) said call center querying a second party regarding predetermined preferences of said first party;
c) one of said first party and said call center selecting a third party to perform said requested action, said selection based at least in part on said predetermined preferences;
d) said call center contacting said third party through said secure portal and arranging for performance of said requested action by said third party; and,
e) said third party obtaining a performance acknowledgment from said first party after performance of said requested action and transmitting said performance acknowledgment to said second party through said secure portal.

2. A method according to claim 1 further comprising a step of said call center obtaining data associated with a specific geographic location of said first party prior to step c).

3. A method according to claim 2, wherein said selection in step c) is based at least in part on said specific geographic location and said predetermined preferences of said first party.

4. A method according to claim 2, wherein said data associated with a specific geographic location of the first party is obtained by said call center through said secure portal.

5. A method according to claim 1, wherein said step of initiating a transaction includes said first party contacting said call center through said secure portal via one of an audio communication, a video communication and a data communication.

6. A method according to claim 1, wherein said step of obtaining said performance acknowledgment from said first party in step e) includes a step of said third party electronically capturing said performance acknowledgment.

7. A method according to claim 6, wherein said step of electronically capturing said performance acknowledgment includes one of reading of a data card, recording a signature on an electronic tablet, recording a voice print, and scanning a biological feature of said first party.

8. A method according to claim 1, wherein said call center and said secure portal are integrally associated.

9. A method of executing a transaction associated with performance of an action involving first, second and third parties, said first party including an associated transporter and an associated transport administrator, said third party including an associated servicer and an associated service administrator, said method comprising the steps of:
a) said associated transporter of said first party initiating a transaction by contacting a designated call center through a secure portal and requesting performance of an action;
b) said call center obtaining data associated with a specific geographic location of said associated transporter;
c) said call center querying a second party regarding predetermined preferences of said first party;
d) said call center querying a plurality of potential third parties through said secure portal with regard to at least one of inventory, availability, and response time;
e) said call center obtaining data associated with a geographic location of said associated servicer relative to said specific geographic location of said first party for one or more of said plurality of potential third parties;
f) said call center ranking said potential third parties based upon individual responses to said query of step d) and said geographic location of said associated servicer relative to said geographic location of said associated transporter;
g) one of said transporter, said call center and said associated transport administrator selecting a specific third party based upon said ranking of potential third parties;
h) said call center requesting authorization from said associated transport administrator through said secure portal for performance of said requested action by said selected third party;
i) upon receiving an affirmative response from said associated transport administrator through said secure portal, said call center contacting said selected third party through said secure portal and requesting performance of said action;
j) upon receiving an affirmative response from said third party through said secure portal, said call center arranging performance of said action by said third party through said secure portal; and,
k) said selected third party obtaining a performance acknowledgment from said associated transportation person after performance of said requested action and transmitting said performance acknowledgment to said second party through said secure portal.

10. A method according to claim 9, wherein one of steps b) and e) include obtaining data from an external service provider through said secure portal.

11. A method according to claim 9, wherein prior to receiving an affirmative response from said associated transport administrator to said request in step h) said call center receiving a negative response from said associated transport administrator to said request in step h), said call center repeating steps g) and h) until said affirmative response is received in step i) responsive to a subsequently selected third party.

12. A method according to claim 9, wherein prior to receiving an affirmative response from said third party to said request in step i) said call center receiving a negative response from said associated transport administrator to said request in step i), said call center repeating steps g), h) and i) until said affirmative response is received in step j) responsive to a subsequently selected third party.

13. A method according to claim 9, wherein prior to receiving an affirmative response from said associated transport administrator to said request in step h) said call center receiving a conditional response from said associated transport administrator to said request in step h), said method further comprising steps of:
said call center contacting said selected third party and requesting performance of said action;
upon receiving an affirmative response from said third party, said third party performing an evaluation of the requested action and forwarding said evaluation to said associated transport administrator through said secure portal;
one of said associated transporter, said call center and said third party requesting authorization based on said evaluation for performance of said action from said associated transport administrator through said secure portal;
upon an affirmative response from said associated transport administrator, said third party performing said requested action; and,
said selected third party obtaining a performance acknowledgment from said associated transporter after performance of said requested action and transmitting said performance acknowledgment to said second party through said secure portal.

14. A method according to claim 9, wherein one of step b) and e) includes a step of said call center querying an external service provider through said secure portal to obtain data associated with said geographic location of one of said first party and said servicer.

15. A method according to claim 9 further comprising said call center determining an estimated time of arrival of said servicer based upon said geographic location of said servicer relative to said geographic location of said first party.

16. A method according to claim 15, wherein step f) includes said estimated time of arrival in ranking said potential third parties.

17. A method according to claim 9, wherein said querying of potential third parties in step d) includes querying respective service centers of said potential third parties with regard to at least one of inventory, availability and response time.

18. A system for executing a transaction associated with performance of an action involving a plurality of parties, said system comprising:
a) a secure portal having means for sending and receiving one of audio, video and data communications;
b) a call center in communication with said secure portal, said call center having means for directing communications into and out of said secure portal and computing means for processing said communications;
c) a database of predetermined preferences of a first party that is maintained by a second party;
d) means for communicating among said secure portal, said database, and at least one of said first party, said second party and said third party;
e) means for said third party to electronically obtain a performance acknowledgment from said first party after performance of a requested action; and,
f) means for transmitting said performance acknowledgment to said second party through said secure portal.

19. A system according to claim 18 further comprising means for determining a geographic location of one of said first and third parties.

20. A system according to claim 50 further comprising means for evaluating said predetermined preferences of said first party and prioritizing a plurality of potential third parties based upon said predetermined preferences.
